(19) United States
(12) Patent Application Publication
(10) Pub. No.: US 2013/0067190 A1
(43) Pub. Date: Mar. 14, 2013

(54) MEMORY ALLOCATION METHOD, PROGRAM AND SYSTEM

(71) Applicants: Thomas R. Gissel, Raleigh, NC (US); Hiroshi Horii, Tokyo (JP)

(72) Inventors: Thomas R. Gissel, Raleigh, NC (US); Hiroshi Horii, Tokyo (JP)

(73) Assignee: International Business Machines Corporation, Armonk, NY (US)

(21) Appl. No.: 13/606,513

(22) Filed: Sep. 7, 2012

(30) Foreign Application Priority Data
Sep. 9, 2011 (JP) 2011-197051

(51) Int. Cl. G06F 12/02

(52) U.S. Cl. 711/171; 711/E12.002

(57) ABSTRACT

A method for creating a buffer of a special class for accessing a specified memory space. The method includes the steps of: creating, by a processor of the computer system, a buffer of a special class, the buffer including a memory space that the processor is not permitted to access; and creating, by the processor, an accessible buffer of the class in access-permitted memory space by slicing off a portion of a created buffer of the class in response to a designation of the access-permitted memory space and size, where the processor includes: the special class for the buffer for accessing a memory space specified by an absolute address; and a function to create the class by slicing off the portion of the memory space specified by the class.

### CROSS-REFERENCE TO RELATED APPLICATION

This application claims priority under 35 U.S.C. §119 from Japanese Patent Application No. 2011-197051 filed Sep. 9, 2011, the entire contents of which are incorporated herein by reference.

### BACKGROUND OF THE INVENTION

1. Field of the Invention

The present invention relates to a computer memory allocation technique. More specifically, the present invention relates to a technique for Java® processor or the like to perform memory allocation in a memory area managed by another processor.

2. Description of Related Art

Recently, Java® is often used as processors for constructing systems to provide multi-platform compatibility. Large scale-distributed processing systems have employed the Key-value store (KVS) technique in recent years. In the KVS technique, many key-and-value combinations are stored as an associative array using hash (Hash Map). FIG. 1 shows such data structure implemented in Java®. In this structure, values saved in KVS are stored as HashMap 104 containing multiple entries in Java® heap 102 in a server system implementing KVS.

Upon receiving a request from a client system, the server system constructs a ByteBuffer object 106 in the heap 102. For this reason, the type of each data piece stored in the HashMap is the ByteBuffer itself or a byte array (byte[]), which is an actual data of the ByteBuffer object.

However, locating many objects on the heap 102 in this manner reduces space in the heap and causes frequent garbage collection. Since overhead of garbage collection increases along with an increase in the number of objects in the heap, overhead of garbage collection in JVM running KVS inevitably becomes high.

As a solution to this problem, a method uses a mechanism shown in FIG. 2, in which entities of objects are located on a memory area (off heap 202) outside the control by Java®, and an off heap map 204 containing pointers to anchors for the entities is located on the heap 102. In this mechanism, an object entity of a byte buffer 206, created when the server system receives a request from a client system, is located on the off heap 202. Thus, by locating the object entities on the off heap 202, memory consumption and the number of objects in the heap 102 can be reduced, and overhead of garbage collection can also be reduced.

Java® uses a mechanism called Java® Native Interface (JNI) to handle objects in the off heap 202 with a standard API. Rob Gordon, “Essential JNI: Java Native Interface,” 1998, Prentice Hall provides examples and details on JNI.

In particular, JNIEnv->NewDirectByteBuffer(address,size) is called to create a ByteBuffer that points to a previously-allocated memory block 302 in the off heap 202. Address is the absolute address of a memory block in the off heap, and size is the size of the memory block. Ron Hitchens, “Java Nio”, 2002, O'Reilly provides examples and details on ByteBuffers of Java®.

Although it is possible to create the ByteBuffer pointing to the memory block 302 at the previously-allocated address in the off heap 202 by calling JNIEnv->NewDirectByteBuffer(address,size), there is a problem because overhead of the creation processing is practically very high.

More specifically, JNIEnv->NewDirectByteBuffer(address,size) includes the following steps.

1. Java® processor calls JNI library processor with address and size required by Java®.

2. JNI library (C, C++) processor executes JNIEnv->NewDirectByteBuffer(address,size).

3. JNI library processor calls Java® processor that constructs and initializes some Java® objects for creating ByteBuffer.

4. Java® processor returns created ByteBuffer to JNI library processor.

5. JNI library processor returns returned ByteBuffer to Java® processor.

6. Java® processor uses available ByteBuffer.

However, since each of these steps has high overhead, the entire overhead is extremely high. Every time a server system receives a request from a client system and needs to create a ByteBuffer, the aforementioned processing JNIEnv->NewDirectByteBuffer(address,size) in high overhead needs to be executed. As such, this causes a problem of degradation in overall performance.

### SUMMARY OF THE INVENTION

Accordingly, one aspect of the present invention provides a method for creating a buffer of a special class for accessing a specified memory space, the method including the steps of: creating, by a processor of the computer system, a buffer of a special class, the buffer including a memory space that the processor is not permitted to access; and creating, by the processor, an accessible buffer of the class in access-permitted memory space by slicing off a portion of a created buffer of the class in response to a designation of the access-permitted memory space and size, where the processor includes: the special class for the buffer for accessing a memory space specified by an absolute address; and a function to create the class by slicing off the portion of the memory space specified by the class.

Another aspect of the present invention provides a non-transitory computer readable storage medium tangibly embodying a computer readable program code having computer readable instructions which when implemented, cause a computer to carry out the steps of a method including: creating a buffer of a special class, the buffer including a memory space that the processor is not permitted to access; and creating an accessible buffer of the class in access-permitted memory space by slicing off a portion of a created buffer of the class in response to a designation of the access-permitted memory space and size, where the processor includes: the special class for the buffer for accessing a memory space specified by an absolute address; and a function to create the class by slicing off the portion of the memory space specified by the class.

Another aspect of the present invention provides a system for creating a buffer of a special class for accessing a specified memory space, the method including: a processor device configured to: create a buffer of a special class, the buffer including a memory space that the processor is not permitted to access; and create an accessible buffer of the class in access-permitted memory space by slicing off a portion of a created buffer of the class in response to a designation of the access-permitted memory space and size, where the processor includes: the special class for the buffer for accessing a memory space specified by an absolute address; and a function to create the class by slicing off the portion of the memory space specified by the class.

### BRIEF DESCRIPTION OF THE DRAWINGS

FIG. 1 is a diagram showing an example of an on heap map.

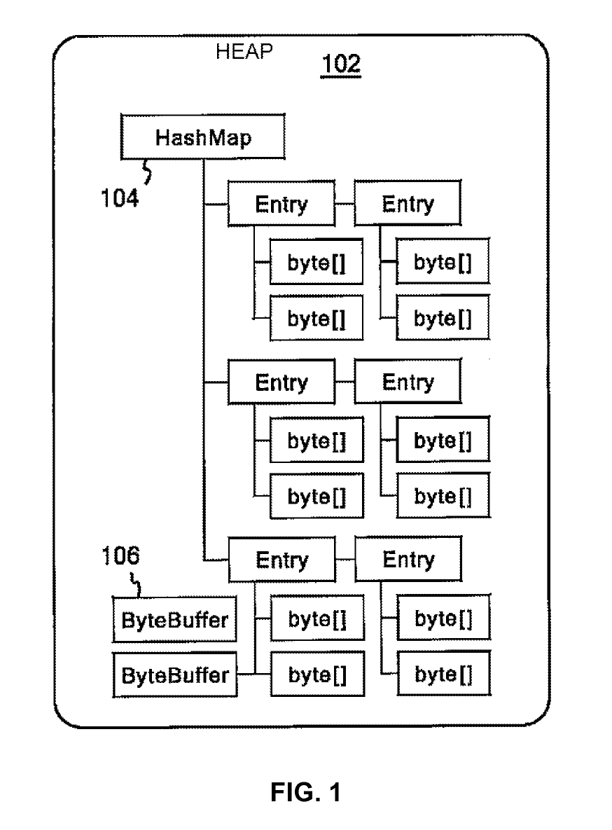

FIG. 2 is a diagram showing an example of an off heap map.

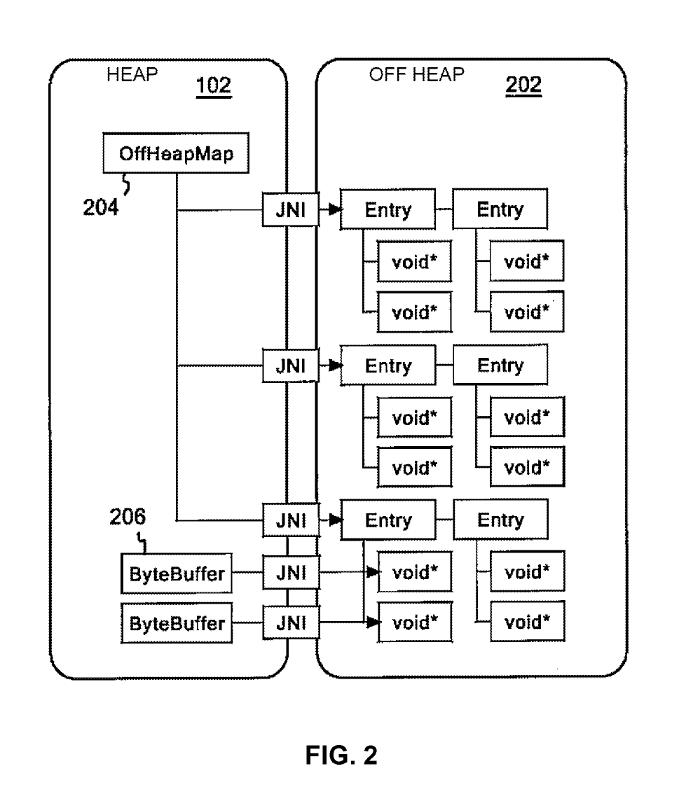

FIG. 3 is a diagram showing a correspondence between a ByteBuffer in a heap and a memory block in an off heap according to an embodiment of the present invention.

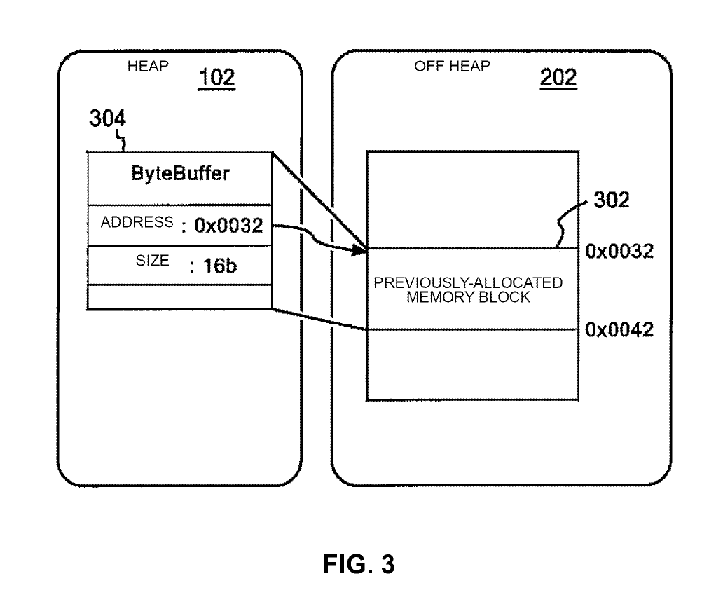

FIG. 4 is a block diagram showing an example of hardware according to an embodiment of the present invention.

FIG. 5 is a diagram showing layers of a software configuration according to an embodiment of the present invention.

FIG. 6 is a diagram showing a flowchart according to an embodiment of the present invention.

FIG. 7 is a diagram showing a second flowchart according to another embodiment of the present invention.

FIG. 8 is a diagram showing a correspondence between a phantom ByteBuffer in a heap and memory blocks in an off heap according to an embodiment of the present invention.

### DETAILED DESCRIPTION OF THE PREFERRED EMBODIMENTS

The above and other features of the present invention will become more distinct by a detailed description of embodiments shown in combination with attached drawings. Identical reference numbers represent the same or similar parts in the attached drawings of the invention.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It is an objective of the present invention to reduce overhead for creation of a buffer for accessing an off heap by Java® processor or the like using a predetermined interface such as JNI.

According to the present invention, the above problem can be solved by previously creating one or multiple ByteBuffers, which are particularly referred to as phantom ByteBuffers in this invention, of sizes as large as possible within the range of the specification.

In a preferable embodiment, JNIEnv->NewDirectByteBuffer(address,size) is similarly called to create the phantom ByteBuffers, and the processing itself requires the aforementioned overhead. At this time, the range specified by the address and size of the phantom ByteBuffer is set so as to cover an assumed range of memory block addresses in an off heap. Note, however, that the predetermined specification of Java® nio limits the size of a ByteBuffer to 2 GB, and thus a single phantom ByteBuffer may not be large enough to cover the assumed range of memory block addresses in the off heap.

For this reason, it is preferable that multiple phantom ByteBuffers of different addresses be created so as to widely cover the assumed range of memory block addresses in the off heap.

In the above-mentioned state where multiple phantom ByteBuffers are ensured so as to widely cover the assumed range of memory block addresses in the off heap, upon receipt of a request from the system for creating a ByteBuffer with an address and size, the program having prepared the phantom ByteBuffers finds the phantom ByteBuffer including the range specified by the address and size, and calls position( ) limit( ) and slice( ) which are methods of the ByteBuffer. In other words, a ByteBuffer of the required address and size is cut out by: invoking position( ) with the requested address as an argument; invoking limit( ) with the requested size as an argument; and invoking slice( ). The ByteBuffer thus cut out can be used as a buffer for the specified memory block in the off heap. Upon receipt of another request from the system for creating a ByteBuffer using a range specified by an address and size, the same processing is repeated.

That is, once the phantom ByteBuffer is created, a ByteBuffer subsequently requested by the system can be created, just by slicing the phantom ByteBuffer by use of a method of the ByteBuffer with relatively low overhead.

Note that if there is no phantom ByteBuffer including the range specified by the address and size required by the system, a phantom ByteBuffer including the range specified by the address and size needs to be created with predetermined overhead. However, such processing may be almost unnecessary and may rarely happen if phantom ByteBuffers are previously created according to a cautious forecast.

In addition, if a large number of phantom ByteBuffers are prepared, high overhead may be required to identify a phantom ByteBuffer including a specified range for creating each ByteBuffer. However, this overhead can be reduced by deleting a specific phantom ByteBuffer that frequently fails to include a range specified by a requested address and size.

According to the present invention, it is possible to reduce overhead for creation of a buffer for accessing an off heap by Java® processor or the like using a predetermined interface such as JNI. The overhead is reduced because the buffer is created in response to a request only by slicing off a portion of a phantom ByteBuffer previously created.

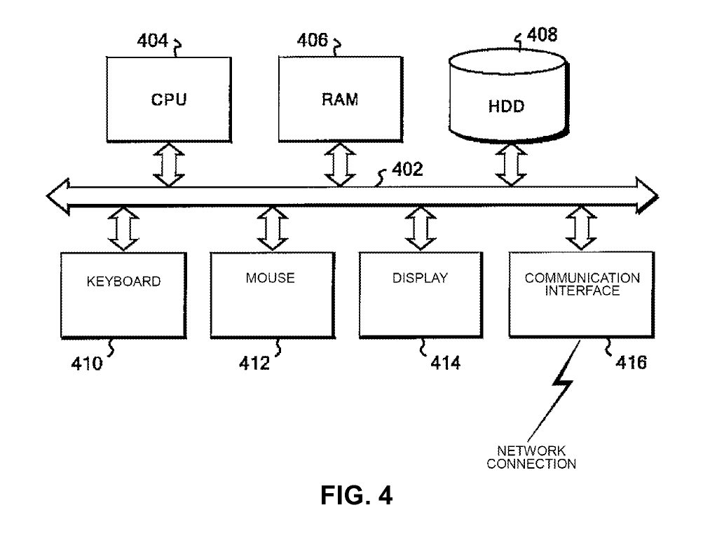

FIG. 4 shows a block diagram of computer hardware for implementing a system configuration and processing of an embodiment of the present invention. In FIG. 4, connected to a system bus 402 are: a CPU 404, a main memory (RAM) 406, a hard disk drive (HDD) 408, a keyboard 410, a mouse 412 and a display 414. The CPU 404 is preferably based on a 32-bit or 64-bit architecture, and Pentium (trademark) 4 of Intel Corporation, Core (trademark) 2 Duo of Intel Corporation, Athlon (trademark) of AMD or the like may be used, for example. Capacity of the main memory 406 is preferably not less than 4 GB, or more preferably not less than 8 GB.

An operating system is stored in the hard disk drive 408. Any of operating systems such as Linux (trademark), Windows (trademark) 7, Windows (trademark) XP, Windows (trademark) 2003 server of Microsoft Corporation, and Mac OS (trademark) of Apple Inc., may be used as long as it is compatible with the CPU 404.

A program, such as Apache, which causes the system to operate as a web server is also saved in the hard disk drive 408, and is loaded into the main memory 406 upon startup of the system.

A Java® Runtime Environment program for implementing a Java® virtual machine (VM) is also saved in the hard disk drive 408, and is loaded into the main memory 406 upon startup of the system.

The hard disk drive 408 may also include a JIT compiler which converts a bytecode application program into an operating system-native code and runs the program.

The hard disk drive 408 also stores therein a library to be called by JNI, which is preferably a binary program written in C or C++ and compiled.

The keyboard 410 and the mouse 412 are used to operate graphic objects such as an icon, a taskbar, a textbox and the like displayed on the display 414 in accordance with a graphic user interface provided by the operating system.

Although not limited to this, the display 414 is preferably a 32 bit true color LCD monitor with a resolution not lower than 1024×768. The display 414 is used, for example, to display a start up screen of a program implementing the present invention.

A communication interface 416 is preferably connected to a network with an Ethernet® protocol. By use of a function provided by Apache, the communication interface 416 receives a processing request according to a communication protocol such as TCP/IP from a client computer (not shown), or returns a processing result to the client computer (not shown).

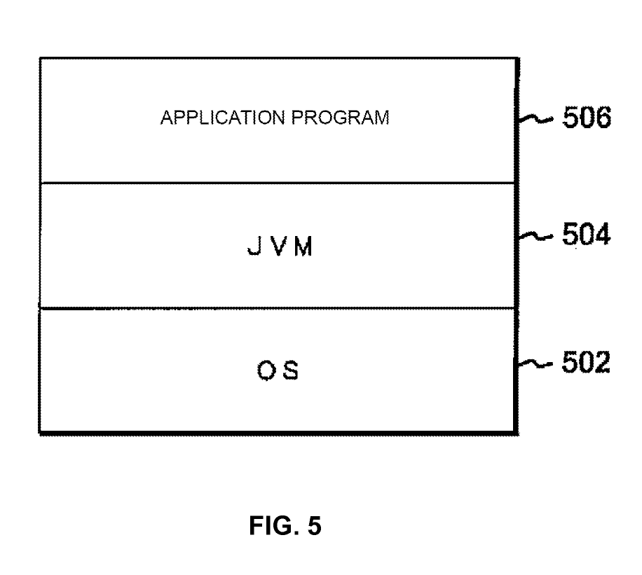

FIG. 5 is a diagram showing layers of a program or a process. An operating system (OS) 502 runs on the hardware shown in FIG. 4, a Java® virtual machine (JVM) 504 runs on the OS 502, and an application program 506 runs on the JVM 504. The source code of the application program 506 is compiled with javac or the like and is saved in the hard disk drive 408 in the form of bytecode. The JVM 504 includes a JNI interface and its library, and the application program 506 of the invention uses the JNI interface.

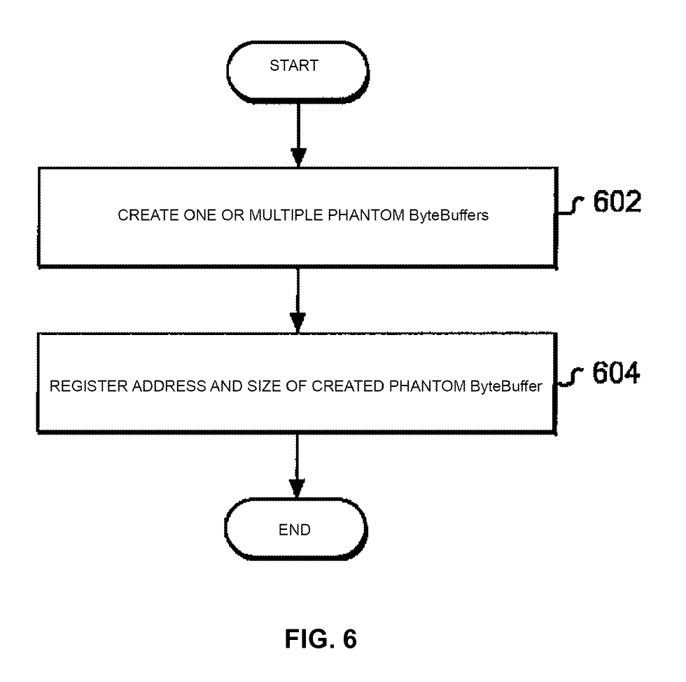

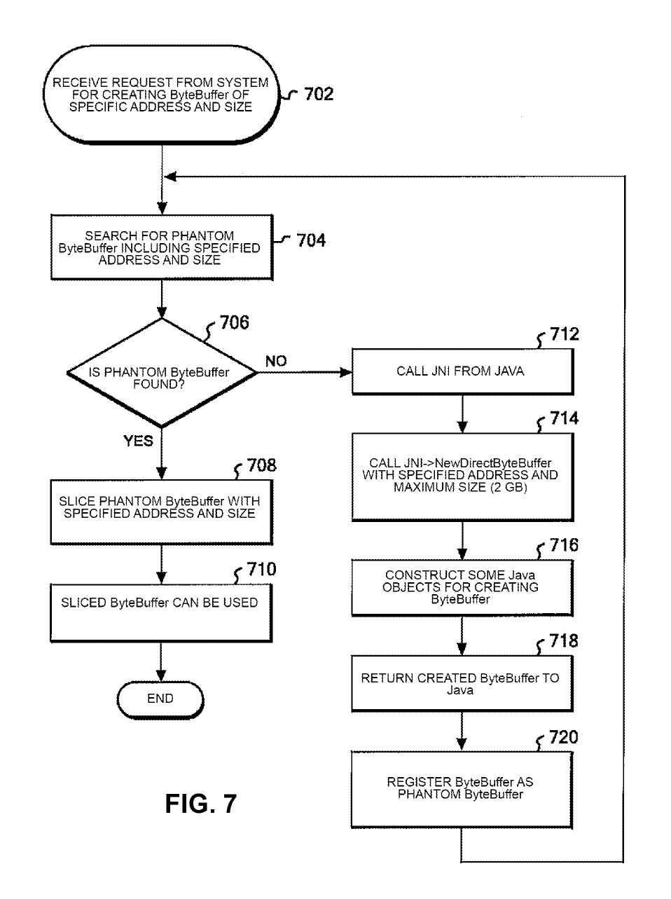

Next, processing executed by the application program 506 will be described with reference to flowcharts shown in FIGS. 6 and 7.

The flowchart in FIG. 6 relates preferably to processing executed by the application program 506 upon startup of the application program 506. In step 602, the application program 506 creates one or multiple phantom ByteBuffers. Particularly in this invention, a phantom ByteBuffer will be referred to as a ByteBuffer pointing to a memory space which may include an area to which the JVM is not allowed access. Here, address is selected so as to cover the range of addresses allocated to memory blocks in the memory in the off heap. size is preferably set to 2 GB which is the maximum value that can be set within the range of the specification of java. nio. The processing for creating a phantom ByteBuffer is the same as that shown in steps 712 to 720 in the later-described flowchart shown in FIG. 7.

The range of off heap memory to be pointed to by a single phantom ByteBuffer is limited to 2 GB. Therefore, if the assumed range of off heap memory of the application program 506 exceeds 2 GB, a single phantom ByteBuffer is insufficient to cover the assumed range of off heap memory of the application program 506. In this case, multiple phantom ByteBuffers of different addresses are created so as to cover as much as possible the entire assumed range of the off heap memory of the application program 506.

In step 604, the application program 506 registers values of address and size of the created phantom ByteBuffer, preferably to a predetermined region in the heap, as table data such as a hash table.

The flowchart in FIG. 7 relates to processing of the application program 506 for creating a ByteBuffer in response to a request from the system.

Step 702 is initiated when the application program 506 receives, from the system, a request for creating a ByteBuffer of a specific address and size.

Subsequently, in step 704, the application program 506 accesses the information registered in step 604 of FIG. 6, and searches for a phantom ByteBuffer which includes the range indicated by the specified address and size.

In step 706, the application program 506 determines whether or not a phantom ByteBuffer fulfilling the condition specified in step 704 is found, and if so, slices the found out phantom ByteBuffer according to the specified address and size. position( ) limit( ) and slice( ) methods of the ByteBuffer are used for this operation. More specifically, a ByteBuffer of the required address and size is cut out by: invoking position( ) with the requested address as an argument; invoking limit( ) with the requested size as an argument; and invoking slice( ). Thus in step 710, the cut out ByteBuffer can be used as a buffer for the specified memory block in the off heap. Hence, the processing for creating the ByteBuffer is terminated.

Returning to step 706, if no phantom ByteBuffer fulfilling the condition specified in step 704 is found, the application program 506 creates a phantom ByteBuffer of a range starting from the specified address. To be more precise, in this processing, the application program 506 calls JNI from Java® in step 712.

Then in step 714, the application program 506 calls JNIEnv->NewDirectByteBuffer(address,size) with the specified address and maximum size (2 GB).

Next in step 716, the application program 506 constructs some objects for creating a ByteBuffer.

In step 718, the created ByteBuffer is returned to Java®.

Thereafter in step 720, the application program 506 registers the created ByteBuffer as a phantom ByteBuffer.

Hence, the processing returns to step 704. Then, since the phantom ByteBuffer is newly registered, the corresponding phantom ByteBuffer is found in step 704, the determination in step 706 turns positive, and in step 708 the ByteBuffer is created by slicing in the aforementioned manner.

The steps 712 to 720 carried out when determined in step 706 that no phantom ByteBuffer is found have high overhead. However, a corresponding phantom ByteBuffer is found in most cases if phantom ByteBuffers are prepared so as to cover the memory addresses of a previously assumed range. Accordingly, the determination in step 706 turns positive and the process proceeds to step 708, so that the problem of overhead hardly arises.

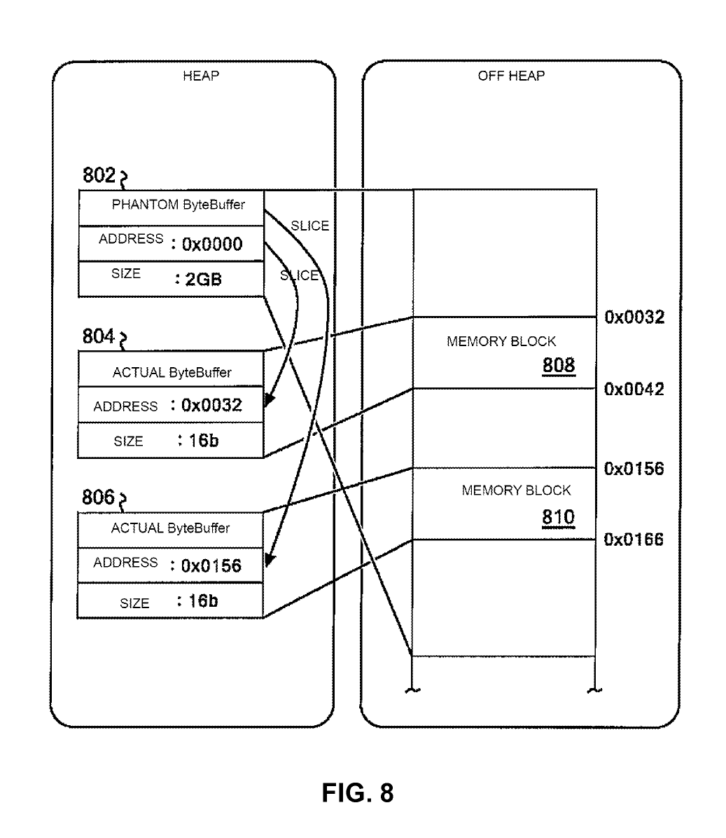

FIG. 8 is a diagram showing a schematic representation of how a phantom ByteBuffer is sliced and actual ByteBuffers are cut out therefrom. In FIG. 8, a phantom ByteBuffer 802 is created in advance in step 602 of FIG. 6.

Then as shown in step 702 of FIG. 7, upon receipt of a request for creating a ByteBuffer from the system, an actual (i.e., other than phantom) ByteBuffer 804 is created by slicing the phantom ByteBuffer in step 708, and the actual ByteBuffer 804 points to a memory block 808 in the off heap.

Subsequently, upon receipt of another ByteBuffer creation request from the system, an actual ByteBuffer 806 is created by slicing the phantom ByteBuffer in step 708, and the actual ByteBuffer 806 points to a memory block 810 in the off heap.

As has been described, once a phantom ByteBuffer is created at the cost of the overhead, any number of desired actual ByteBuffers can thereafter be created just by slicing the phantom ByteBuffer. The processing of slicing the ByteBuffer is completed within Java®, which, unlike JNI, has relatively low overhead.

Hereinabove, an embodiment of the present invention has been described in an example of creating a buffer pointing from Java®, by way of JNI, to a memory block in the off heap. It should however be noted that the invention is not limited to specific hardware and Operating system, processor or application program, as long as it is a processor including a native interface for another system.

What is claimed is:

1. A method for creating a buffer of a special class for accessing a specified memory space, the method comprising the steps of:
creating, by a processor of the computer system, a buffer of a special class, said buffer comprising a memory space that said processor is not permitted to access; and
creating, by the processor, an accessible buffer of said class in access-permitted memory space by slicing off a portion of a created buffer of said class in response to a designation of said access-permitted memory space and size,
wherein said processor comprises:
said special class for said buffer for accessing a memory space specified by an absolute address; and
a function to create said class by slicing off said portion of said memory space specified by said class.

2. The method according to claim 1, further comprising the steps of:
creating a plurality of said buffers of said class in an area within said memory space that said processor is not permitted to access; and
recording a buffer address and buffer size of each of said buffers of said class.

3. The method according to claim 2, wherein said step of creating said accessible buffer further comprises the steps of:
searching a plurality of said created buffers of said class whose said addresses are recorded to find a certain buffer comprising a range indicated by designated address and size; and
slicing a found buffer.

4. The method according to claim 3, further comprising the step of:
creating an additional buffer of said class comprising said address of said memory space that said processor is not permitted to access when said step of searching said plurality of said created buffers fails to find said certain buffer of said class having said address.

5. The method according to claim 1, wherein said step of creating the buffer of said class comprising a memory space that said processor is not permitted to access further comprises the step of:
creating said buffer in maximum allowable size.

6. The method according to claim 1, wherein said step of creating said accessible buffer of the class further comprises the steps of:
designating a starting point with position( );
designating a size with limit( ); and
invoking slice( ) method after said step of designating said size with limit( );
wherein said processor is Java® and said class of said buffer is ByteBuffer; and
wherein said step creating said buffer of said class is executed by calling a JNI interface.

7. A non-transitory computer readable storage medium tangibly embodying a computer readable program code having computer readable instructions which when implemented, cause a computer to carry out the steps of a method comprising:
creating a buffer of a special class, said buffer comprising a memory space that said processor is not permitted to access; and
creating an accessible buffer of said class in access-permitted memory space by slicing off a portion of a created buffer of said class in response to a designation of said access-permitted memory space and size,
wherein said processor comprises:
said special class for said buffer for accessing a memory space specified by an absolute address; and
a function to create said class by slicing off said portion of said memory space specified by said class.

8. The computer readable storage medium according to claim 7, further comprising the steps of:
creating a plurality of said buffers of said class in an area within said memory space that said processor is not permitted to access; and
recording a buffer address and buffer size of each of said buffers of said class.

9. The computer readable storage medium according to claim 8, wherein said step of creating said accessible buffer further comprises the steps of:
searching a plurality of said created buffers of said class whose said addresses are recorded to find a certain buffer comprising a range indicated by designated address and size; and
slicing a found buffer.

10. The computer readable storage medium according to claim 9, further comprising the step of:
creating an additional buffer of said class comprising said address of said memory space that said processor is not permitted to access when said step of searching said plurality of said created buffers fails to find said certain buffer of said class having said address.

11. The computer readable storage medium according to claim 7, wherein said step of creating the buffer of said class comprising a memory space that said processor is not permitted to access further comprises the step of:
creating said buffer in maximum allowable size.

12. The computer readable storage medium according to claim 7, wherein said step of creating said accessible buffer of the class further comprises the steps of:
designating a starting point with position( );
designating a size with limit( ); and
invoking slice( ) method after said step of designating said size with limit( );
wherein said processor is Java® and said class of said buffer is ByteBuffer; and
wherein said step creating said buffer of said class is executed by calling a JNI interface.

13. A system for creating a buffer of a special class for accessing a specified memory space, the method comprising:
a processor device configured to:
create a buffer of a special class, said buffer comprising a memory space that said processor is not permitted to access; and
create an accessible buffer of said class in access-permitted memory space by slicing off a portion of a created buffer of said class in response to a designation of said access-permitted memory space and size,
wherein said processor comprises:
said special class for said buffer for accessing a memory space specified by an absolute address; and
a function to create said class by slicing off said portion of said memory space specified by said class.
